(19) United States
(12) Patent Application Publication
(10) Pub. No.: US 2006/0041452 A1
(43) Pub. Date: Feb. 23, 2006

(54) All-in-one electronic method and a technology designed to collect, integrate, analyze & display medical & health data ( brand name : health-e-window)

(76) Inventor: Avinash Uttamrao Kulkarni, Livingston, NJ (US)

Correspondence Address: Pan Health Inc.;Suite E., 36 State Route 10 West, East Hanover, NJ, 07936, US

(21) Appl. No.: 11/205,563

(22) Filed: Nov. 1, 2005

Related U.S. Application Data
(60) Provisional application No. 60/602,174, filed on Aug. 17, 2004.

(51) Int. Cl. G06F 19/00

(52) U.S. Cl. 705/3

(57) ABSTRACT

When patients are not complying with the optimal treatment of their disease it will often have a long-term adverse effect on their health. The present invention offers an effective method to help patients' manage their disease (an important aspect of this is to increase the compliance). The present invention is a part of a system for acquiring health related and healthcare practice related data, related an individual, forwarding the data to a remote location where the data can be processed and allowing one to access the data from various other remote locations over the internet or other network. This present invention is a method and a technology designed to collect, integrate, analyze & display medical & health data generated using personal medical devices via various communication modes.

### 1. CROSS REFERENCE TO RELATED PATENT APPLICATIONS

The invention has no cross-reference to related patent applications.

### 2. STATEMENT REGARDING FEDERALLY SPONSORED RESEARCH OR DEVELOPMENT

The invention has no Federal Sponsorship.

### 3. BACKGROUND OF THE INVENTION

The invention is a part of a system consisting of a process, computer hardware and computer software for collecting and integrating; health data of human beings. It also makes use of web technology, IVR, Telephones, Cell Phones, SMS technology, Paging technology for collection, integration and display of health related data which is then transferred to remote central processing servers for accumulating, monitoring health; and health practices. In short; the invention is a method to collect, integrate, analyze and display medical & health data generated using personal medical devices via various communication modes.

### 4. BRIEF SUMMARY OF THE INVENTION

Many patients with a serious disease do not comply with the treatment they have been prescribed. Often patients forget to take their medicine regularly. This is often the scenario for diseases where there is no instant reaction when the prescribed treatment is not followed. Even though the condition of the disease does not worsen instantly the consequences can be still very severe. This is for example the case with diabetes. The non-compliance rate for diabetes patients is as high as 50%¹. Many patients can improve the condition of their disease significantly by increasing their compliance.
¹ Hamman R F, Michael S L, Keefer S M, Young W E Impact of policy and procedure changes on hospital days among diabetic nursing home residents-Colorado. MMWR 1984; 33:621-9

As mentioned before; the invention is a part of the system that can increase the compliance by communicating with the patient about his health and the compliance to the prescribed treatment. This communication is automatically taken care by the system once the patient is registered with it.

The system can be used effectively for managing many different health related issues including diseases, diet program, physical exercise programs . . . etc. The system gathers information from patient's health care providers and people otherwise related to the patient. This information is gathered using a variety of communication methods. The information about the patient and the treatment that should comply with; is stored in the system. On the other hand; some information can be also gathered automatically by calling the patient reminding and inquiring about the compliance to the treatment. The system integrates all the patient's health information and uses this to create a customized algorithm for managing the disease and treatment.

In sum, the invention is a tool that helps the patient improve the condition of most diseases and also offers a great value.

4.1 Definition of the Invention

This invention is a method and a technology designed to collect, integrate, analyze and display medical & health data generated using personal medical devices via various communication modes.

4.2. Health Data—Capture and Management

Health-e-Window has capabilities to collect the health data. It contains a mechanism for data capture for the following health modules:

List A. (Examples of Data Capture Functionality Managed by the Invention)

1. Blood Pressure Log.
2. Blood Glucose Log.
3. Personal eight log.
4. Breathing Pattern log.
5. Mood Pattern Log.
6. Diet Diary.
7. Exercise Log. (To monitor/record calories burnt)
8. Sleep Pattern Log.
9. Menarche/Menopause Log.
10. Medication Diary.
11. Health History.

This data is collected from the patient to maintain the medical/health history. Each of the above data elements can be captured while it is measured under specific conditions mentioned below in this document.

Example: An individual has been advised by the physician to measure and monitor the blood pressure on a daily basis while on a medication for a blood pressure problem. It is cumbersome for the individual to maintain the records of the measurements over the period of time. The Health-e-Window™ can help the patient do this without keeping track of all the measurements.

The Health-e-Window™ in its own has the capabilities to capture, store and display the health related data in a tabular and graphical format and it makes use of simulator of an LCD display device and would use the computer screen for display.

4.3. Processes and Methods for Collecting Data

It is very difficult to obtain patient's information from individuals and to accumulate it into a database for facilitating, monitoring a patient's health and healthcare practices. Health related data for an individual are generated at multiple locations like physician's office, hospitals, labs and mostly at the individual's home. The data that gets generated at an individual's home is of extreme importance, which on the other hand is very difficult to collect at one central location. For example, home blood sugar tests, home blood pressure tests, dietary details, exercise details, etc. It is inconvenient and time demanding for an individual to keep the track of all this data and make it available globally; and also provide abilities for accumulation, monitoring, tracking, analysis and compliance promotion. For most individuals, it is unrealistic to do the above functions manually. Such individuals can conveniently make use of the communication devices such as telephone, cell phones, SMS, two-way pager, dictation system to enter and view data.

The individuals make use of personal health monitoring and recording devices such as Glucose Meter, Blood Pressure (BP) measurement and monitoring meter, treadmill, and exercise equipment such as Pulleys etc. These instruments are not in a position to store the health data/readings for a long time. For storing the new records, the old records have to be overwritten/deleted due to the limitations of data storing capacity or inability of storing data.

It is hence desirable to invent a method that allows an individual to record the health data with the help of easy communication devices and technology; for logical analysis and treatment. Additionally, it would be also desirable that this data collection would be performed as per the specific needs of an individual through absolute customization and stored at a secure central remote data server.

The invention offers a user-friendly and convenient yet comprehensive way to retrieve information from most of the health data sources and use the data to suggest the individual, how to manage health in general more effectively.

Processes and Methods for Collecting Data from Individuals:
Individuals can make use of the system's web interfaces developed for entering, viewing editing personal health data. For accessing these web interfaces, a password entry to identify an individual is defined.
Individual calls—communication with the data center via telephone, cell phones, web interfaces or two-way pagers. System can use speech and/or voice recognition or smart cards or a password entry to identify the individual. The individual would be prompted to choose different options to enter his health related data, which is transmitted, to a remote central server. The logic of the questions to be asked by the system to the individual is customizable.
The system would call an individual by telephone or beeper and the individual is prompted to enter the health related data by choosing appropriate options. The data is transmitted to remote central server form where it can be accessed.
Individuals can also call the data center and dictate the health data for any of the health elements mentioned in the above said list. This data can then be transcribed by the transcribers and then entered into the system to be stored in the database against the name/identification of that individual.

The data captured can be accessed through a web-browser or by fax-on-demand or by manual request, by the individual or anyone authorized. The individual can give access for this data to the physician or any other person wanting to share this information. This information collected can be analyzed on the basis of data collected or with the presence or absence of the data. The physician or any person the individual authorizes can then decide the decision-making logic to be used to take appropriate action.

### 4.4. OBJECTIVES AND SUMMARY OF THE INVENTION

The following are objectives of the present invention:
A. To provide a method of collection of healthcare information and personal health related data from an individual using web interfaces, telephones, mobile phones and two-way paging systems, dictation system which in turn can be stored at a centralized database.
B. To provide a method of making a telephone (Land phones and cell phones) call, web interfaces to the individual to collect the relevant health data using telephone keypad or speech recognition and easy prompts.
C. To provide a method of analyzing data or its absence; to generate healthcare warning signals/recommendations for medical compliance promotion.
D. To guide the individuals and provide methods and steps to analyze health data by means of graphical and tabular results generated through the query options when selected and submitted to the centralized processing system.
E. To provide a portable, secure and confidential form of data with easy dissemination tools and global availability.
F. To have a method by which an individual can choose voice prompts and visual web interface in the language of the choice, using the multi-lingual system
G. To provide means through which the health related data can be synchronized to and from the Personal Digital Assistant (PDA), Palm devices, Hand held computers, personal health measurement and monitoring, metering gadgets, Electrocardiogram (ECG/EKG) machines, Blood Glucose meter, Blood Pressure meter etc.
H. To present the data collected and synchronized from the above said meters, instruments in format can be displayed on the screen of the computer/PDA/Palm device.

The present invention relates to a method for acquiring data related to a person's healthcare habits and healthcare information generated at the home, office, place of exercise, doctors office, hospital etc for forwarding the data to a remote location where it can be processed. The invention further relates to customization features to be provided to an individual for making the experience of data entry and data dissemination, easy, user friendly, effective and valuable.

The invention further includes an intelligent processing of the data. With the outcome of this data acquired, the invention includes generation of triggers, data sets, flags and notices based on the values of the data acquired or absence of date. These triggers, data sets etc can be presented to the individual, the individual's physician or whoever is authorized by the individual to receive such information. Such triggers can be made available in the form of tabular sets or graphs, which can further be presented to a physician or can be used for further analysis of the data. The Health-e-Window IS the inventions used for entering, editing and analyzing the health related data from the individuals.

The invention includes a process for capturing data provided by the individual in plain speech and translating and transcribing the same to fit appropriate database structures using manual transcription and data entry. The data entry executive on the behalf of the individual can then enter the transcribed data into the centralized system.

### 5. DETAILED DESCRIPTION OF THE INVENTION

The present invention relates to a process and method for gathering healthcare data from individuals and also describes a manner in which the data can be processed and presented in an user friendly graphical and tabular manner. The various ways and means of collecting data; the use of already invented processes and devices like the ordinary touch tone phone, mobile phones or two-way pager using the interactive voice response technology.

Also the user friendly web interfaces specially developed to guide the individuals to record the health data such as Blood Pressure, Blood Glucose, Weight, Dietary details, Exercise details, Food consumption details, Rest details, Menarche Menopause values based on the prompts.

In this model, it relates to a method and device for reminding the individual to take medication, remind them for conducting the prescribed tests and also for collecting health related data, while the system is globally available and is able to generate portable and intelligent data. For example, an individual suffering from diabetes has to monitor the blood sugar level at a specific physician prescribed frequency to ensure good health. The individual without the assistance of the subject invention would not be in a position to record the data in a user-friendly fashion for accumulation, monitoring and analysis. With the current invention, the individual can record/enter the data related to the personal health or health of the friends, family members in a timely fashion and at the same time be able to accept the input of the test results for accumulation at the central data server. Depending on the choice, convenience and time availability of the individual, the individual can dial in and input the health related data/test of all headers mentioned under LIST A as above. The system with its intelligent logical system is also now in a position to process the data collected from the individuals.

The Health-e-Window™ accommodates the data sets via the data capturing mechanisms created for the purpose of this invention. Data view section of Health-e-Window takes care of tabular data display of all the data entered with the presence of dates/absence of dates mentioned by the user.

A front-end Digital device can take care of graphical display of data in which Pie chart, Line chart, Bar-charts etc can be created from the data captured in the Health-e-Window.

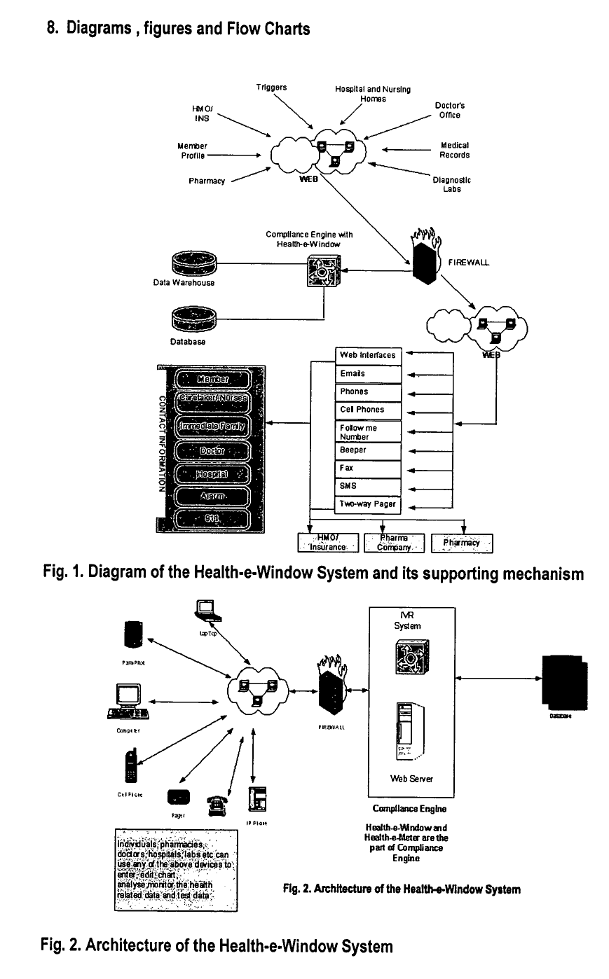

Referring to FIG. 1: one aspect of the present invention relates to the collection of data regarding the health and health care practices of an individual and transmitting and storing this data at a remote central data base server. This figure shows the data being collected from various sources, metered and monitored using some devices like Gluco-Meter, BP meter and fed into the Compliance Engine.™ the current invention shall primarily include the collection of data from individuals using web interfaces and other methods and devices mentioned above and secondarily collecting data from other sources like physician, pharmacy etc, using internet and other technologies/methods of data collection such as dictation into the system by the individual or somebody representing the individual.

An individual using a personal computer, PDA, Palm device, or other hand held device with a web browser or manually by filling an application and transmitting the same to the system administrators can use the system to input data in various ways mentioned before in this same document.

The data collected as the response the reminders, dictations or also the data collected by the use of Health-e-Window web interfaces shall be transmitted to the remote central server and stored for accumulating, monitoring and analyzing via a digital device and display screens created for this purpose.

All the data so collected can be disseminated by the individual or the authorized representative via the internet using a personal computer with the help of a web browser, hand held computing devices with internet connectivity or by manual request in paper and compact disk/smart card/diskette form.

The architectural layers of the system of the present invention include a front-end layer, a transport layer, a service layer and an application layer. Encryption and access security can be utilized to meet the privacy and confidentiality concerns of the users.

The front-end layer comprises of wired/wireless modes of communication. The interfaces that can be supported are:
1) Web Interfaces to be accessed using Internet enabled devices having a capability of launching the applications through a browser
2) Telephone (analog and digital telephones) used for dictation of health data into the system
3) Cellular and Mobile Phones (CDMA, TDMA, GSM) for sending SMS to the system.
4) Personal computers with internet connectivity
5) Portable hand held computers with Internet connectivity and with GUI that encourages data input to the said invention.
6) Web TV
7) Internet Browsing Machines (like the Eye opener® and Mail station®)
8) SMS Server

The Transport Layer is responsible for communicating the data between the individual, his authorized persons and remote data center. At a minimum, it comprises Telephone Network, Cellular and Mobile Phone Network, Paging Networks, PPP, TCP/IP and 802.3 protocols. Other optional protocols such as IPX etc may be supported in future.

The Service Layer provides the essential infrastructure for application platform. It comprises:
1. Typical Internet mandated services such as HTTP services, WWW, GOPHER, and WAIS etc.
2. Databases
3. Interactive Voice Response System
4. Fax Servers
5. Email Servers
6. Paging Servers
7. Operating System
8. Networking Management Software
9. Media Presentation (Audio, video, scripting, etc)
10. Object request broker services and
11. Other application support packages such as GUI packages etc.

The Application Layer provides consumer applications and business-to-business applications including applications that connect health care professionals and businesses with other health care professionals and business.

Encryption and Security can be provided through various technologies including authentication through Secure ID, (allow login after user password authentication), pin numbers, biometric devices for authentication, voice and speech recognition for authentication, readily available encryption schemes such as 128-bit encryption schemes using public encryption protocols, associated user certificates (SSL-ready) and firewalls.

Some illustrations of this application include:

Home Blood Pressure/Pulse Tests: This is a classical example of data generated by an individual at home for prolonged period. Lack of blood pressure control in individuals suffering from hypertension could lead to many serious outcomes. The current invention can be very well used to collect, store, monitor, analyze health, diet, exercise data etc, and also to input the data so generated from the test. This invention now has the composite information of the test occurrence and results in its central repository.

The data so collected can also be used for charting the patient control, drug response, non-compliance etc in composition with other data like dietary habits, exercise habits, this data now becomes more informative and conclusive for healthcare professionals to evaluate for better health care delivery.

Diabetes, Asthma, Weight Control etc are other examples.

Referring to FIG. 2: A patient connects to the system or calls the system from his home or office or from car. Or a physician connects to the system on behalf of the patient. using the already invented process of collecting medical data, the system would allow the user to connect call itself after the user provides appropriate login credentials, then the system authorizes the user to user the voice prompts or web interfaces. The voice prompts will guide the user to input the required readings for Blood Glucose, Blood Pressure etc. The system would also gather the date and time of readings/tests which are helpful while charting the data.

This database would be available to patient to review and update through Internet as well as telephone. The patient can give access to the physician or to any other person with whom the patient wants to share the information. The patient or the physician can decide the decision-making logic to take certain action(s) based on the values entered or based on the presence or absence of the data.

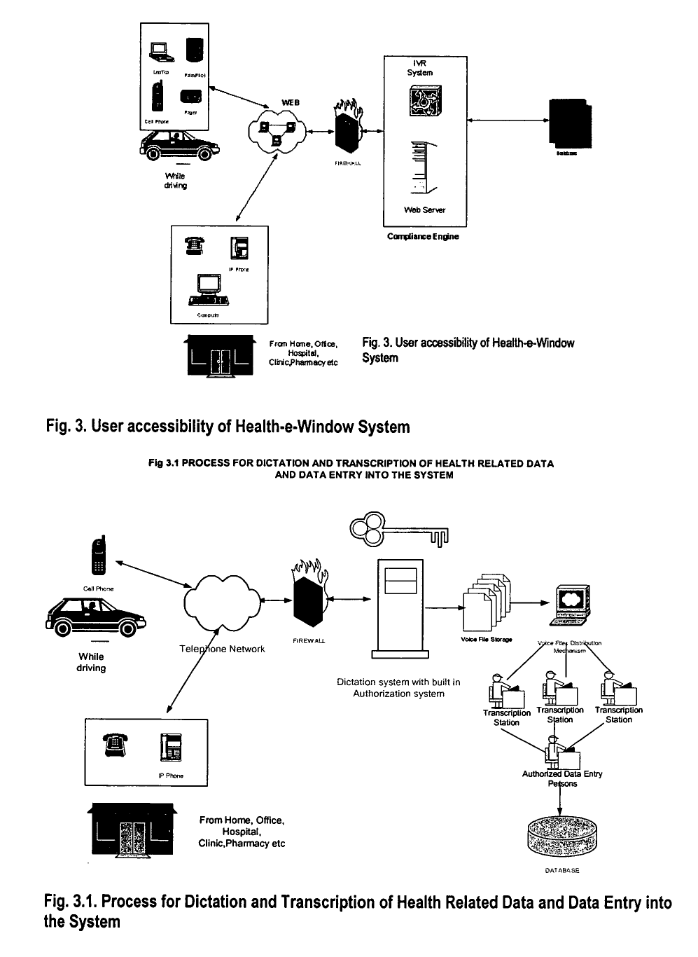

Referring to FIG. 3: It illustration shows how the individual can connect to the system. As explained in the FIG. 2, it would allow the user to log in from multiple devices and multiple locations.

Referring to FIG. 3.1: This illustration shows a system offered to individuals for dictating the health/medical test related data which generates a voice file for dictation. These voice files are further transcribed and then the data is entered into the system. This facility allows individuals dictate data via land phones, iDen phones, cell phones etc.

5.1. Nutrition and Weight Management Module

More than 60 million Americans are actively trying to lose weight and they're struggling—65 percent of adults in America are overweight or obese. Losing weight isn't just about looking better. It's a major health issue. Being overweight directly contributes to increased heart disease, Type II diabetes, hypertension, some cancers, and other preventable diseases. Most of us consume more calories than we burn—consuming just 200 calories a day over the number of calories your body needs can result in a two pound weight gain every month! Knowing your metabolism measurement and logging your food and exercise can change that.

Health-e-Window puts in control of weight and nutrition.

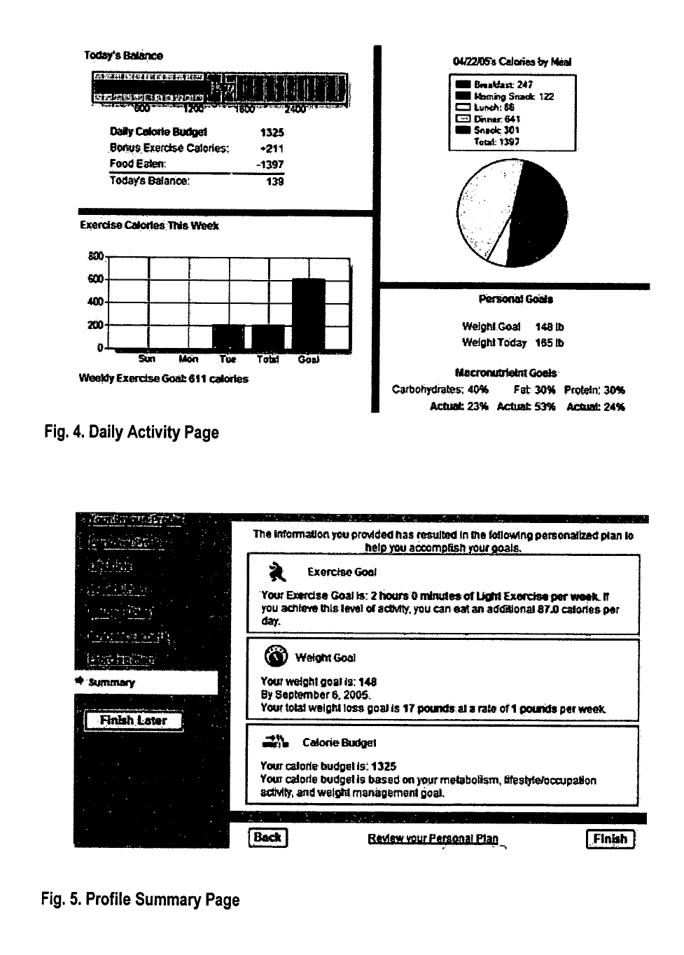

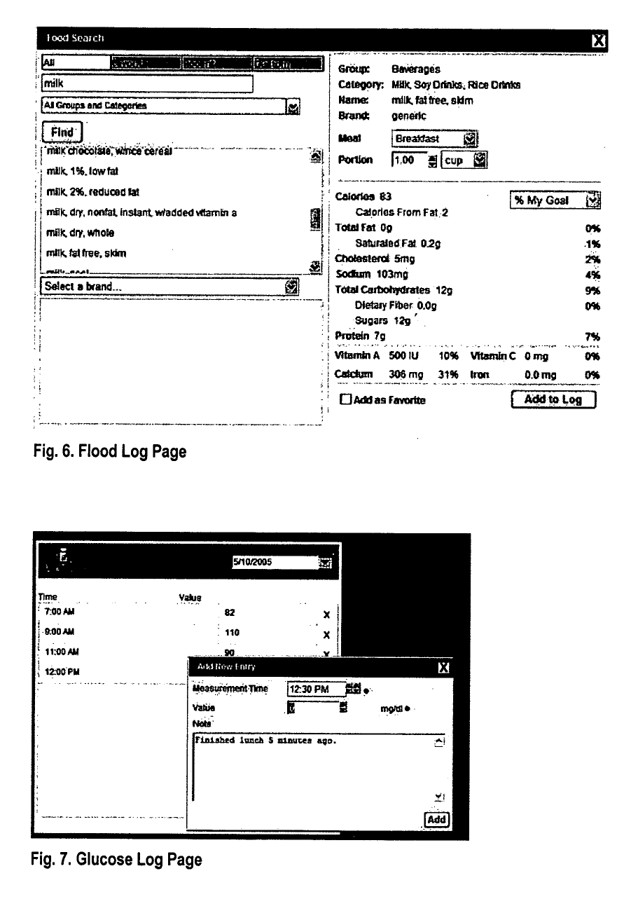

Referring to FIGS. 4, 5, 6 & 7: Health-e-Window™ is an easy-to-use application that helps to create a personalized weight and nutrition management plan based on individual unique metabolism. People burn calories at different rates and knowing how many calories your body burns (metabolism) can mean the difference between gaining or losing weight.

In today's fast-paced environment, “biggie” and “super-sized” have become part of the daily vocabulary—and our diet. So when we decide to commit to a healthier lifestyle, it's not always easy to make the translation and know whether or not we are making the appropriate changes. It has been proven, however, that daily tracking and monitoring of the calories we consume and the calories we burn is the key to successful long-term weight and nutrition management.

Health-e-Window helps to quickly and easily set up weight and nutrition program. We can log and monitor calories, nutrients such as proteins, carbohydrates, fats, cholesterol and others, and log physical activity to achieve your weight goals more effectively than ever before. A food and exercise log is a powerful, proven aid for those looking to manage weight and monitor nutrition. People who track food consumption and exercise lose more weight and keep it off longer than those who don't.

As one track's daily calories and exercise, you become more conscious about what one is putting into the body. It's also easier to identify problem areas. And logging is motivational—one can start to make healthy choices and see results. Health-e-Window also allows one to share your data through the Internet, we can choose a doctor, dietitian, or other healthcare professional, who can make recommendations and provide support.

The following are the salient features of this module:
Personalized weight management program
Individual diet, exercise, and weight management goals
Accurate daily tracking of calories in and calories out
Tracking of weight, body fat, and other important measurements
Monitor health measurements like cholesterol and blood pressure
Conveniently track glucose measurements each day
Thousands of foods and hundreds of exercises available in the database
Ability to enter custom foods and favorites
Extensive reporting, including nutrient analysis and more
Co-brand the application to carry your logo and colors

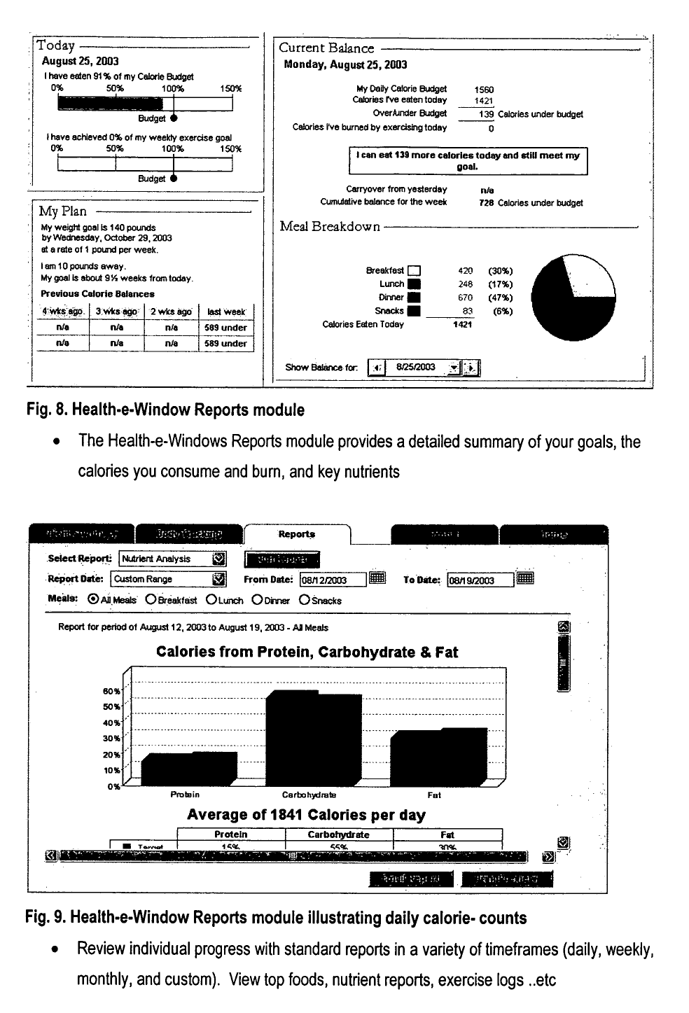

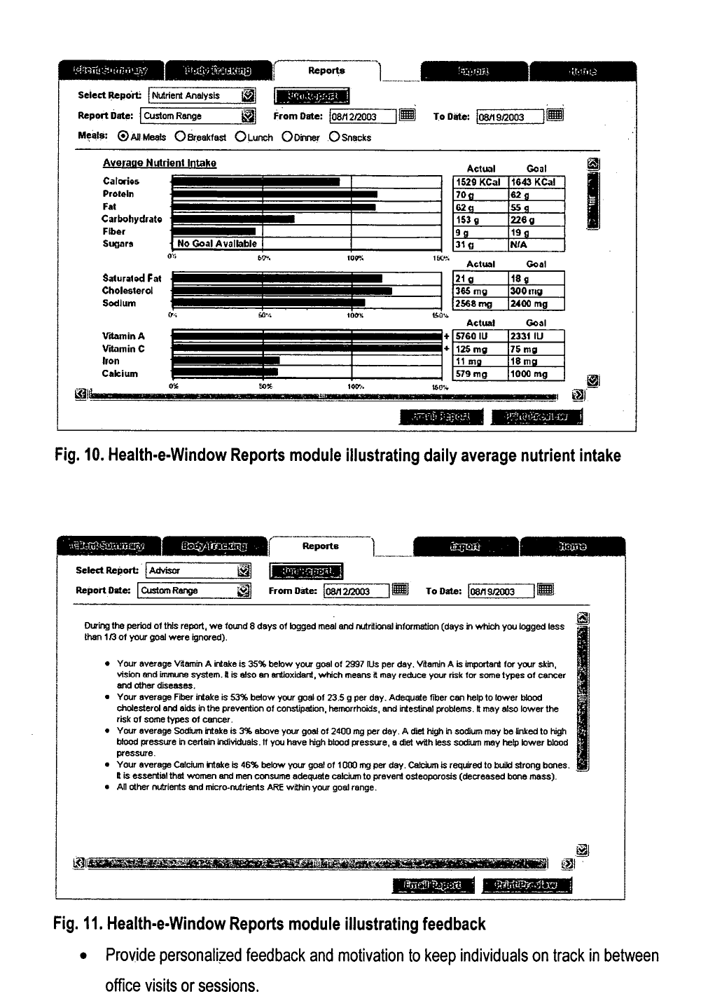

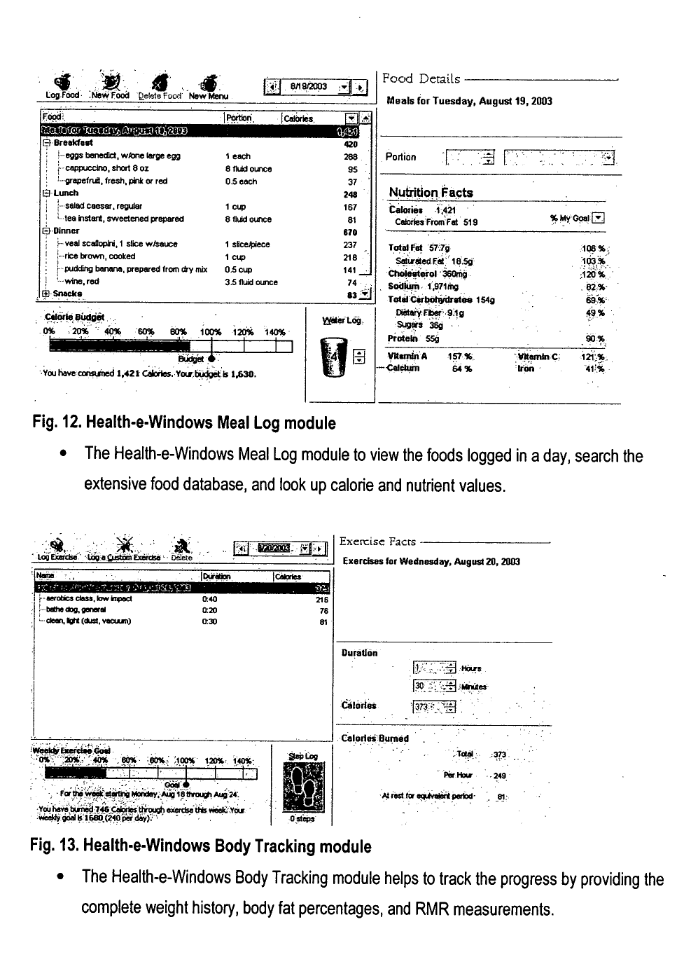

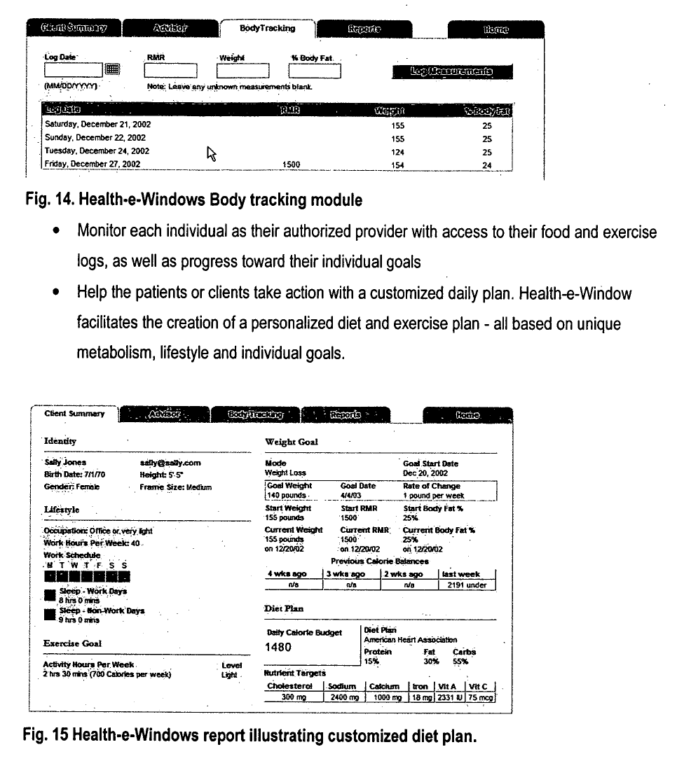

Referring to FIGS. 8, 9, 10, 11, 12, 13, 14 & 15: Heath-e-Window health management system uses information about individual nutrition and weight management goals to develop a complete, personalized program.

It can be used to establish and track your nutrients, daily calorie budget, and exercise targets—and get instant feedback on the progress.
Personalized program based on individual unique metabolism.
Set weight management and nutrition goals.
Accurately track calories in and calories out.
Track protein, carbohydrates, saturated fats, cholesterol, fiber, sodium and more for better health and nutrition management.
Select the preferred eating plan or design a custom diet.
Add favorite foods and create personal menus.
Easily adjust the program as personal metabolism changes.
Access a database of more than 300 exercises and 4,000 foods, including brand-name foods and menu items from national restaurant chains.
Convenient and easy to use

People do not have the information they need to be successful in weight management. People need to know how many calories they consume and how many calories they burn. Effective weight management requires knowledge of caloric balance. By using Health-e-Window you have the ability to measure a clients' Resting Metabolic Rate(RMR), the largest component of energy expenditure, for the first time, detailed.

The Health-e-Window is very convenient and, if used correctly, can provide you with valuable information. Americans continue to battle with weight management. The number of overweight or obese individuals continues to increase at epidemic proportions.

5.2. Analyzer Module

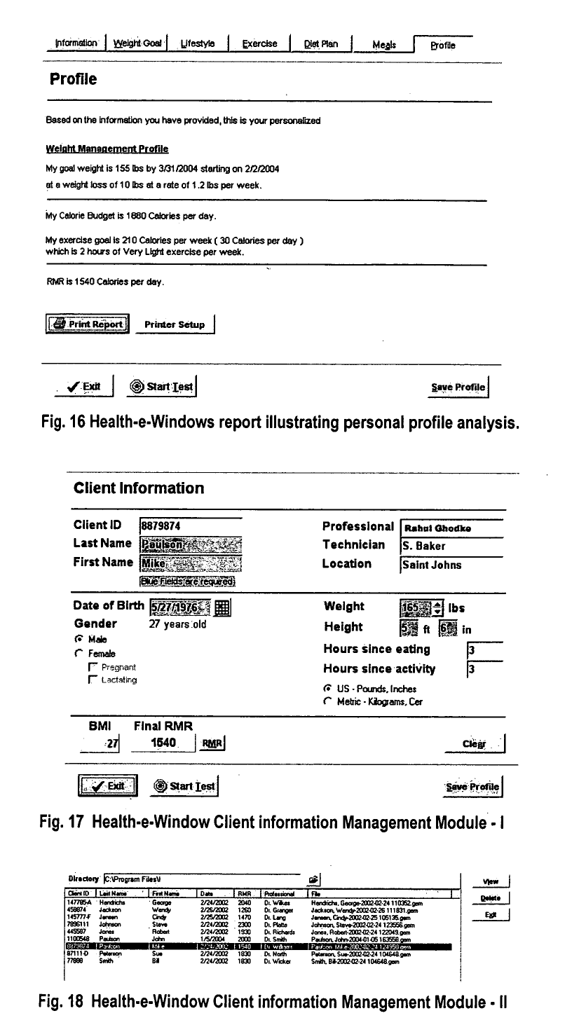

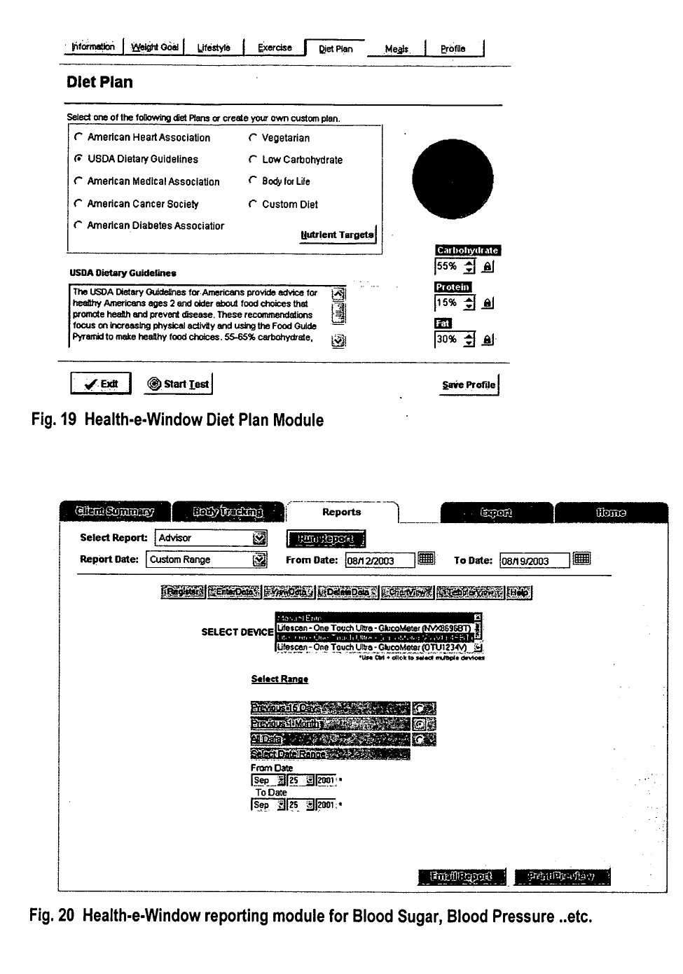

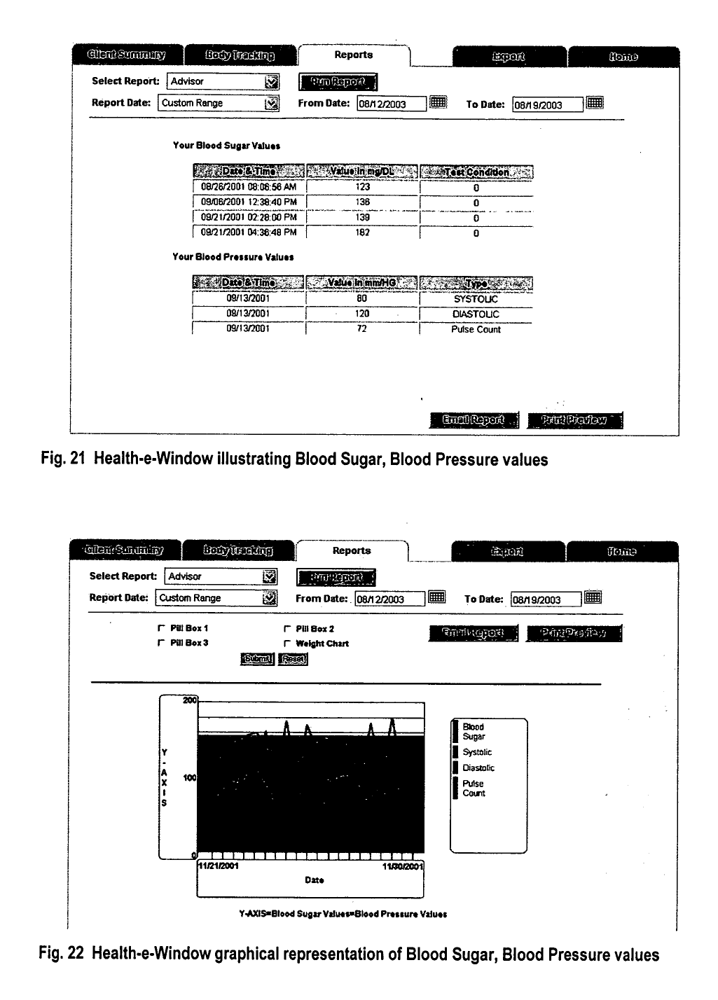

Referring to FIGS. 16, 17, 18, 19, 20, 21 & 22: Health-e-Window ensures that the individuals are getting the information they need to make progress toward their weight and nutrition management goals by using Health-e-Window Analyzer. It supply's them with their personalized calorie budget, based on their unique RMR measurement, and get them on the path to success.

Features and Benefits

Create and print a personalized calorie budget based on the metabolism, lifestyle and individual weight and nutrition goals
View client's real-time data during their metabolism measurement
Capture and store individual metabolism measurements for future reference and profile comparisons
Ability to playback previously recorded metabolism measurements for viewing and analysis
Captures important user information to create a personalized daily calorie budget based on their unique metabolism.
Save and review information and multiple tests for an unlimited number of clients.
Quick and easy viewing make it simple to keep track of multiple clients for dieticians.
Help users select a diet plan that gives them the greatest opportunity for success—including the ability to create a custom diet plan based on their needs and preferences
   5.3. Values Captured by the System

Following are the values that are captured using the Health-e-Window (Features Column as below). Every value is taken with an Event Date (Start/End dates where ever applicable). Health-e-Window provides tabular data display for all the sub modules and Graphical display for Blood Pressure, Blood Glucose, Weight etc. The Health-e-Meter complements Health-e-Window by providing graphical data display facility.

Blood Pressure Log

Systolic Values
Diastolic Values
Pulse Count Values
   Blood Glucose Log

Conditions as follows:
No Meal
Post Meal
Pre Meal
Fasting
   Personal Weight Log

Conditions as follows:
Before Workout
After Workout
Workout Non Specific
After Meal
Before Meal Non Specific
   Breathing Patten Log

Conditions/Values as follows
Rate
Unit
Conditions
Severity Values
Diet Condition
Exercise Condition
Medication Condition
   Mood Pattern Log

Conditions/Values as follows:
Mood Type (e.g. Great, Calm, stressed, sad, angry etc)
Mood duration (Hrs Or Days)
Diet Condition
Exercise Condition
Medication Condition
   Diet Diary

Conditions/Values as follows:
Meal Type (Break Fast, Lunch, Dinner, Snacks)
Food Code—Taken from Database
Serving Style (Table Spoon, Scoop, Slice, Cup etc)
Medication (Crocin, Aspirine etc.)
Points for Food

Depending on the Food code, Health-e-Window will calculate the content values of following items in selected food item.

PROTINES, CARBOHYDRATES, FATS, FIBERS, SUGAR, SODIUM, ALCHOHOL, NICOTINE.

Exercise Log (To See/record Calories Burnt)

Conditions/Values as follows:
Exercise Equipment (Stretchers, Pulley, Chain etc)
Quantum (Miles/Weight)
Exercise Mode (Bowling, Walk, Run, Bike, Skiing, Typing, Tennis, Typing etc.)
   Sleep Pattern Log
Rest Type (Meditation, Deep Breathing, Snooze, Sleep)
Rest Start Time:
Rest End Time:
Quality of Rest (Scale 1-10)
Dreams/Thoughts (good, bad)
Medicines Taken (Crocin, Aspirin etc)
   Menarche/Menopause Log
Flow (Heavy, Medium, Low)
Cramps (Yes/no)
Mood Irritable (Yes/no)
Hot Flashes (Yes/no)
Exercise Condition
Medication Condition
Menopausal?? YES/NO
Weight Value
Sleep Pattern (Regular/Disturbed)
PMS/PMDD (Yes/no)

Medication Diary: Medicines prescribed versus consumed figures with dates

Health History: Values for Good health versus poor health on dates

Special Features of Health-e-Window

1. It can provide reminders to the users using IVR on land phone, Cell phone, Pager, Email, Fax.
2. Health-e-Window takes care of prescriptions. Complete history can be maintained. And retrieval is possible at will.

This invention includes tools by which patient compliance can be promoted effectively and non-compliance related costs to the healthcare systems be reduced.

5.4. Software Approach:

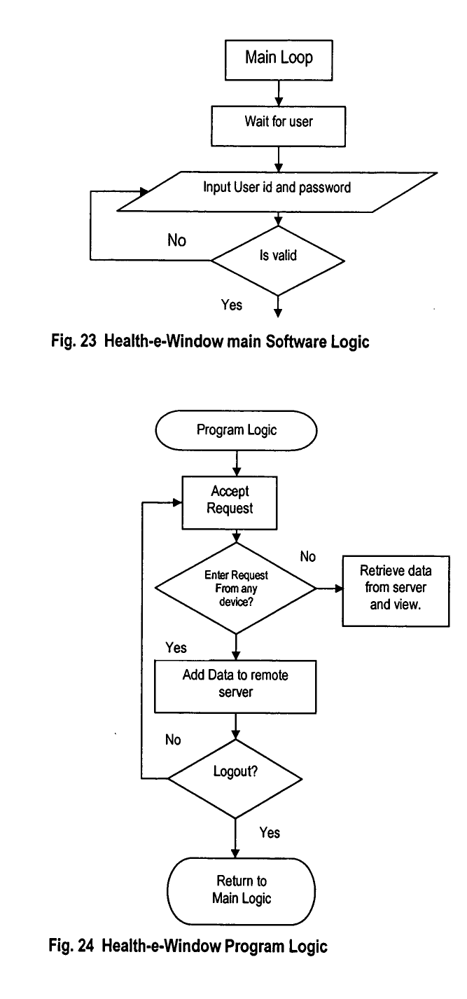

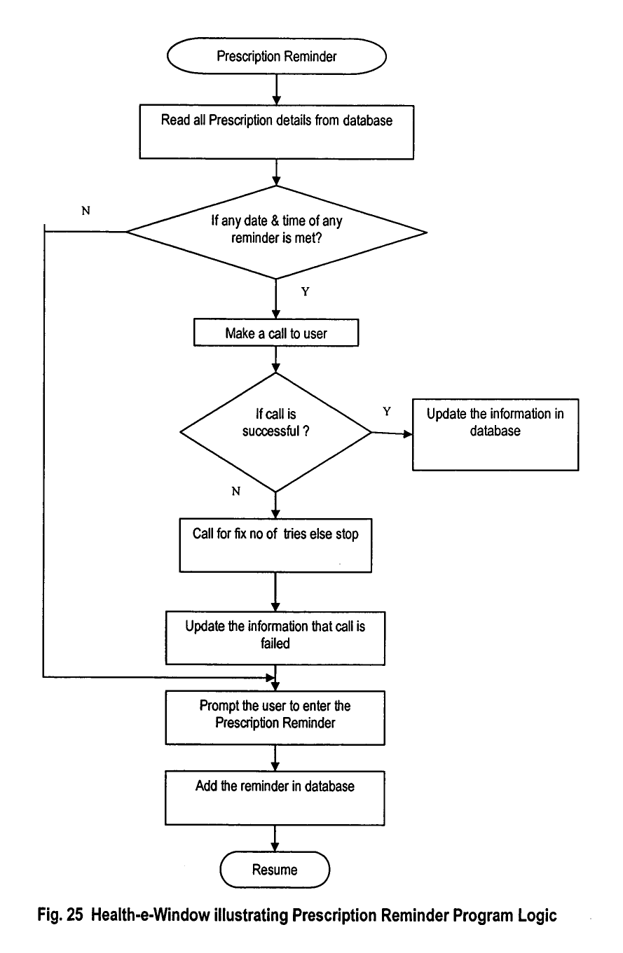

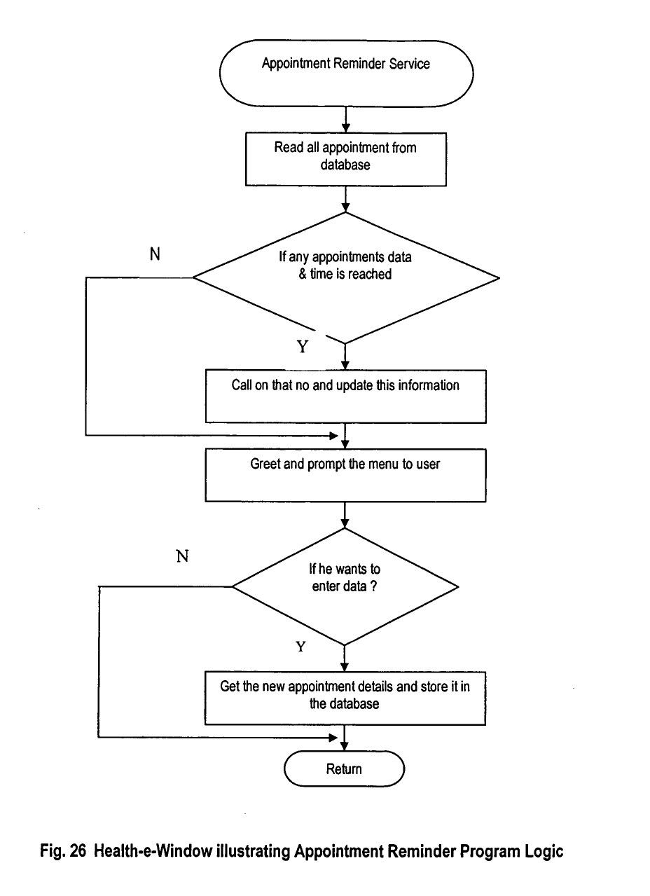

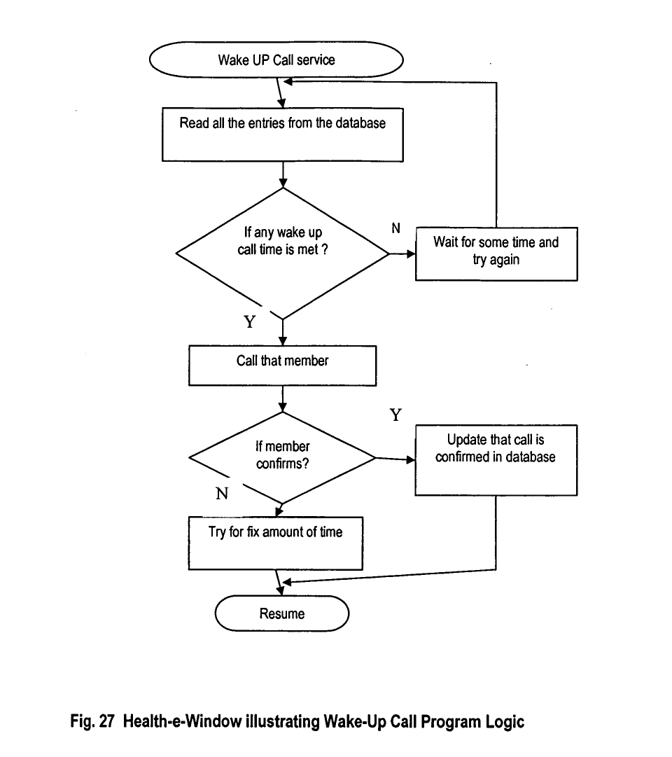

Main logic—Referring to FIG. 23: Following flowchart shows the view of working of the system in brief. The basic purpose of the system is to log the health related values of the individual member. Thus it is a vital role of the system to differentiate each user from another. This is achieved by issuing the unique id and password to each member. Thus first the member has to give this piece of information before claiming any service of the Health-e-Window system.
The main part of the Health-e-Window system is to check for the user's validity and to reject the invalid user's request. This is achieved by comparing the user input with the already stored values on the secured central server. If this value matches then the user is allow to enter the system. Else the user will be prompted for valid user id and password again and again.
Once the user validates him/her as a valid user, then he/she is allowed to access the functionality of the system further. This includes either adding or viewing the health data in the central database.
Main Program Logic—Referring to FIG. 24: Following flowchart shows the main programming logic of health-e-window. In health-e-window, the main task after checking the validity of user is to check what actually the user wants to do? Either he/she may want to only access the previously written health values or either wants to add new health values. Here the data is get stored on the remote central database. The user can either enter the data manually by the GUI forms or other such interfaces accompanying with the system or he/she can also record it from the devices such as glucose meter, blood pressure meter etc.
As far as to health-e-window system goes, there is no difference in these two ways of entering the data. Ultimately the logic is to extract this data, and to store it in remote central server securely. The user is later able to view this data either in tabular fashion or in a graphical fashion.
Prescription Reminder—Referring to FIGS. 25, 26 & 27: This service checks for prescription reminders. This service first reads all of the details from the database which stores the information about the various prescription reminders set by the user. This information needs to be programmed in the system by the user or doctor
As shown in the flowchart, the prescription reminder logic works as follows:
It first checks whether the current date and time is not similar to any of the reminder date and time. If it detects the scheduled reminder date and time is same, then it calls that user for reminding about the said prescription.
The system keeps this information about the calls. It may happen that user is not available or his/her phone is busy. In this case, the system will try to call him again for a fix number of times. But if the system fails to contact user after calling him several times, it merely stores that record to just ensure the user that the system was failed to contact him.
This service, also gives the facility to add the new prescription reminder in the database. This details are validated and then added to the database. Note that while the user is entering new prescription details in the database, the system is still checking for the new date and time for the reminder. This ensures that every date and time reminder indeed gets checked.
   5.5. Use of Other Suppliers Technologies

Computer Telephony Technology or Interactive Voice Response (IVR) adapters by Dialogic Corporation/Intel Corporation/Brooktrout, Inc, will be used in Personal Computers/Servers and connected to the analog or digital telephone lines & Customized voice processing software called VB Voice by Pronexus, dictation systems from DVI Inc or similar provider shall be used for Interactive Voice Response application development. System will also be integrated with pagers/beepers, 2-way paging systems that would help the process of reminders and data collection through wireless telecommunication equipments.

IVR systems, Paging systems, iDen Phones, web interfaces are the part of this invention and will be used to record health data from individuals.

This system will also be integrated with the web-based system developed for collecting the health data from individuals.

The data being acquired on a regular basis and hence it becomes essential to show/present the data to individuals after he/she supplies required login credentials to the web interfaces.

1) I claim to invent a method that allows an individual to record the health data with the help of easy communication devices and technology; for logical analysis and treatment. Additionally, it would be also desirable that this data collection would be performed as per the specific needs of an individual through absolute customization and stored at a secure central remote data server. The invention offers a user-friendly and convenient yet comprehensive way to retrieve information from most of the health data sources and use the data to suggest the individual, how to manage health in general more effectively.
